(19) United States
(12) Patent Application Publication
(10) Pub. No.: US 2023/0053899 A1
(43) Pub. Date: Feb. 23, 2023

(54) MUSIC GENERATION DEVICE, MUSIC GENERATION METHOD, AND RECORDING MEDIUM

(71) Applicant: Panasonic Holdings Corporation, Osaka (JP)

(72) Inventors: Ikuo MINAKATA, Kyoto (JP); Sawaya HARIGAYA, Tokyo (JP); Takehide MATSUDA, Tokyo (JP)

(21) Appl. No.: 17/886,604

(22) Filed: Aug. 12, 2022

(30) Foreign Application Priority Data
Aug. 19, 2021 (JP) 2021-133991

(51) Int. Cl. G10H 1/00; G10H 1/36; G10H 1/46

(52) U.S. Cl. CPC G10H 1/0025; G10H 1/36; G10H 1/46; G10H 2210/005; G10H 2210/111; G10H 2210/125; G10H 2210/341; G10H 2210/325

(57) ABSTRACT

A music generation device includes: an acquisition unit that acquires first stream data and second stream data different from the first stream data; an accompaniment generation unit that generates accompaniment information, which is music data indicating an accompaniment, based on a change in the first stream data; a melody generation unit that generates melody information, which is music data indicating a melody, based on a change in the second stream data; a melody adjustment unit that adjusts the melody information in accordance with a key of the accompaniment indicated by the generated accompaniment information; a music combining unit that combines the accompaniment information and the adjusted melody information to generate musical piece information; and an output unit that outputs the generated musical piece information.

### FIELD OF THE INVENTION

The present disclosure relates to a technology for automatically generating music based on input data.

### BACKGROUND ART

JP 6575101 B2 discloses a technology for generating “musical piece” based on an output signal of an external environment sensor of a vehicle, generating a “sound effect” based on an output signal of an obstacle sensor, and changing the generated “musical piece” and “sound effect” according to a change in the output signal from at least one of the external environment sensor or the obstacle sensor to create music corresponding to the degree of risk caused by an obstacle.

JP 6398960 B2 discloses a technology for generating music data indicating musical piece based on an output signal of an environment detection sensor or an output signal of a target detection sensor, and changing a scale, a chord, a timing, and a tempo of the musical piece according to a risk of a vehicle.

However, in the above-described related technologies, since a balance between followability to input data and emotionality of music is not achieved, further improvement is required.

Here, the followability to input data means that music follows a change in input data. For example, a tune of music is changed by reflecting a change in tendency of input data.

### SUMMARY OF THE INVENTION

The present disclosure has been made to solve such a problem, and an object of the present disclosure is to generate music in which a balance between followability to input data and emotionality is achieved.

A music generation device according to an aspect of the present disclosure is a music generation device that generates music, the music generation device including: an acquisition unit that acquires first stream data and second stream data different from the first stream data; an accompaniment generation unit that generates accompaniment information, which is music data indicating an accompaniment, based on a change in the first stream data; a melody generation unit that generates melody information, which is music data indicating a melody, based on a change in the second stream data; a melody adjustment unit that adjusts the melody information in accordance with a key of the accompaniment indicated by the generated accompaniment information; a music combining unit that combines the accompaniment information and the adjusted melody information to generate musical piece information; and an output unit that outputs the generated musical piece information.

According to the present disclosure, it is possible to generate music in which a balance between followability to input data and emotionality is achieved.

### BRIEF DESCRIPTION OF THE DRAWINGS

FIG. 1 is a block diagram illustrating an example of a configuration of a music generation device according to a first embodiment of the present disclosure;

FIG. 2A is a diagram illustrating a mechanism of a decision function for determining raising or lowering of a melody;

FIG. 2B is a diagram illustrating a mechanism of a decision function for determining raising or lowering of a melody;

FIG. 2C is a diagram illustrating a mechanism of a decision function for determining raising or lowering of a melody;

FIG. 3A is a diagram illustrating a mechanism of a decision function for determining a rhythm of a melody;

FIG. 3B is a diagram illustrating a mechanism of a decision function for determining a rhythm of a melody;

FIG. 3C is a diagram illustrating a mechanism of a decision function for determining a rhythm of a melody;

FIG. 4A is a diagram illustrating a mechanism for changing a rhythm of a melody by adjusting a melody sound;

FIG. 4B is a diagram illustrating the mechanism for changing a rhythm of a melody by adjusting a melody sound;

FIG. 5A is a diagram illustrating a mechanism of a decision function that determines the use of a chord of a melody;

FIG. 5B is a diagram illustrating a mechanism of a decision function that determines the use of a chord of a melody;

FIG. 6 is a flowchart illustrating an example of processing performed by the music generation device according to the first embodiment of the present disclosure;

FIG. 7A is a block diagram illustrating an example of a configuration of a music generation device according to a second embodiment of the present disclosure;

FIG. 7B is a table summarizing decision functions corresponding to levels;

FIG. 8 is a block diagram illustrating an example of a configuration of a music generation device according to a third embodiment of the present disclosure;

FIG. 9A is a table showing a setting situation of each melody;

FIG. 9B is a table illustrating a setting situation of the table of FIG. 9A;

FIG. 10 is a flowchart illustrating an example of processing performed by the music generation device according to the third embodiment of the present disclosure; and

FIG. 11 is a diagram illustrating an example of an overall configuration of a music generation system according to a fourth embodiment of the present disclosure.

### KNOWLEDGE UNDERLYING PRESENT DISCLOSURE

A method of delivering a state or a change of information using a visual sense is widely used in the world. Graphs and tables are representative examples thereof. Information expression using a visual sense has an advantage of high quantitativity and high accuracy, but has a disadvantage that the meaning cannot be understood unless the expressed symbols or characters are observed and interpreted sequentially. In addition, information expression using a visual sense has a disadvantage that, in a case where the information does not enter the field of view of the other party to whom the information is desired to be delivered, the information is not delivered to the other party.

Meanwhile, application of information expression using a hearing sense has been limited as compared with information expression using a visual sense. Many of information expressions using a hearing sense remain at the level of “warning” using a buzzer sound or the like, and the amount of information to be delivered is very small. However, information expression using a hearing sense has advantages that visual information expression does not have. For example, it is possible to understand an outline of information without concentration, and information is delivered to a large number of people and a wide range. On the other hand, information expression using a hearing sense has a disadvantage of low quantitativity.

Information expression using a hearing sense is said to be classified into three types, “sign”, “language”, and “music” (Tsutomu Ohashi, “sound and civilization: the environmental science of sound”, Iwanami Shoten, Oct. 28, 2003).

The “sign” expresses a certain state change with a single sound (a buzzer sound or the like). In a case of using the “sign”, a plurality of types of information are expressed in various ways such as changing a tone, continuously making a sound, and the like, but basically the information expression ability is low, and only a simple message can be delivered.

The “language” is human words. Since the “language” is language information encoded with a voice, the “language” has a very high information expression ability.

Unlike the former two, the “music” is an artistic information expression capable of expressing “emotions” such as feelings and atmosphere with musical sounds by techniques such as the pitch of a sound, a rhythm, and a chord.

Conventionally, in a user interface (output interface) of an information system, various auditory interfaces have been implemented to deal with a case where a visual interface alone is not enough or to complement a visual interface. Examples of the auditory interfaces include a buzzer sound (a kind of sign) for informing occurrence of an event, text-to-speech, and a voice synthesis message (a kind of language) of a voice response.

However, these auditory interfaces do not take into account acoustic harmony with an ambient sound and abruptly emit a sound in the majority of cases. Therefore, it cannot be said that these auditory interfaces are sensitively excellent user interfaces.

It is conceivable to improve such a disadvantage of the auditory interfaces by a method of delivering information while expressing emotions by using the “music”.

For example, there is a method in which, in a certain situation, in a state where music representing the atmosphere of the situation is played as an acoustic background (background music), information to be delivered is converted into music (foreground music) different from the background music, and the music is musically matched and combined with the background music and played.

In other words, in a case where there is a change in information to be paid attention, foreground music corresponding to the change in the information to be paid attention is varied to deliver the change in the information to be paid attention while relaxing music (so-called BGM music) is played as background music.

Here, the background music is music that fluctuates in a relatively long cycle, and may be music having no theme or directionality such as healing music, but music reflecting season, time, weather, temperature, surrounding conditions, and the like is more suitable in terms of sensitivity.

On the other hand, the foreground music is music in which, when there is a change in information to be paid attention, the flow of sound immediately changes according to the amount of change. That is, the foreground music has high followability to a change in data.

The “background music” and the “foreground music” referred to herein are combined and played as one piece of music, and are generally called an “accompaniment” and a “melody (or tune)”, respectively. Hereinafter, the “background music” and the “foreground music” are referred to as the accompaniment and the melody, respectively.

It has been found that it is possible to audibly deliver a change in a surrounding environment while maintaining a good balance between followability to input data and emotionality of music by using such music in which an accompaniment and a melody are combined.

All the above-described related technologies are technologies for changing music based on an output signal from a sensor provided in a vehicle, and the background music (accompaniment) and the foreground music (melody) are not changed according to a risk. Therefore, the above-described related technologies cannot generate music that can maintain a balance between followability to input data and emotionality of music.

The present disclosure has been made based on such findings.

A music generation device according to an aspect of the present disclosure is a music generation device that generates music, the music generation device including: an acquisition unit that acquires first stream data and second stream data different from the first stream data; an accompaniment generation unit that generates accompaniment information, which is music data indicating an accompaniment, based on a change in the first stream data; a melody generation unit that generates melody information, which is music data indicating a melody, based on a change in the second stream data; a melody adjustment unit that adjusts the melody information in accordance with a key of the accompaniment indicated by the generated accompaniment information; a music combining unit that combines the accompaniment information and the adjusted melody information to generate musical piece information; and an output unit that outputs the generated musical piece information.

With this configuration, the melody indicated by the melody information generated based on the change in the second stream data is adjusted in accordance with the key of the accompaniment indicated by the accompaniment information generated based on the change in the first stream data, the accompaniment information and the adjusted melody information are combined, the musical piece information indicating the musical piece is generated, and the musical piece information is output. As a result, it is possible to generate music that can maintain a balance between followability to input data and emotionality of music.

In the music generation device, the second stream data may include a plurality of pieces of stream data, and the melody generation unit may generate the melody information indicating a plurality of melodies based on a change in each of the plurality of pieces of stream data.

With this configuration, the second stream data includes a plurality of pieces of stream data, and the melody information indicating a plurality of melodies is generated based on the change in each of the plurality of pieces of stream data. Therefore, it is possible to generate music rich in followability and emotionality.

In the music generation device, the accompaniment generation unit may generate the accompaniment information in units of bars, and the melody generation unit may generate the melody information in units of beats.

With this configuration, since the accompaniment information is generated in units of bars and the melody information is generated in units of beats, the balance between the followability and the emotionality can be more reliably achieved.

In the music generation device, the melody generation unit may change at least one of raising or lowering of the melody, a rhythm, a chord, a volume, or a musical instrument based on the change in the second stream data.

With this configuration, at least one of the rising or lowering of the melody, the rhythm, the chord, the volume, or the musical instrument is changed based on the change in the second stream data, so that music with higher followability can be generated.

In the music generation device, the melody generation unit may change a slope in the raising or lowering of the melody based on an amount of change in the second stream data in a case where the amount of change in the second stream data is larger than a predetermined threshold, and the melody generation unit does not have to change the slope in the raising or lowering of the melody in a case where the amount of change is smaller than the predetermined threshold.

With this configuration, in a case where the amount of change in the second stream data is large, the melody is steeply raised or lowered, and in a case where the amount of change in the second stream data is small, the flow of the melody is not changed. Therefore, it is possible to generate a melody having a higher followability to the change in the second stream data.

In the music generation device, the melody generation unit may express a rhythm by generating the melody in such a way that one beat is constituted by sounds represented by a plurality of notes in a case where an amount of change in the second stream data is larger than a predetermined threshold, and generating the melody in such a way that one beat is constituted by a sound represented by one note in a case where the amount of change is smaller than the predetermined threshold.

With this configuration, in a case where the amount of change in the second stream data is large, one beat of the melody is constituted by sounds represented by a plurality of notes, and in a case where the amount of change in the second stream data is small, one beat of the melody is constituted by only a sound represented by one note. Therefore, it is possible to generate a melody having a dynamic feeling with a change in rhythm according to the change in the second stream data.

At least one of the plurality of notes constituting one beat of the melody may be a rest.

With this configuration, since at least one of the sounds represented by the plurality of notes assigned to one beat is a rest, a more dynamic melody can be generated.

In the music generation device, the melody generation unit may generate the melody in such a way that one beat is constituted by a sound including a chord in a case where an amount of change in the second stream data is larger than a predetermined threshold, and the melody generation unit may generate the melody in such a way that one beat is constituted by a single sound in a case where the amount of change in the second stream data is smaller than the predetermined threshold.

With this configuration, in a case where the amount of change in the second stream data is large, one beat of the melody is constituted by a sound including a chord, and in a case where the amount of change in the second stream data is small, one beat of the melody is constituted by only a single sound. Therefore, it is possible to generate a melody having a dynamic feeling according to the change in the second stream data.

In the music generation device, the melody generation unit may set a volume of the melody to a first volume in a case where an amount of change in the second stream data is larger than a predetermined threshold, and the melody generation unit may set the volume of the melody to a second volume lower than the first volume in a case where the amount of change in the second stream data is smaller than the predetermined threshold.

With this configuration, in a case where the amount of change in the second stream data is large, the volume of the melody is set to the first volume, and in a case where the amount of change in the second stream data is small, the volume of the melody is set to the second volume lower than the first volume. Therefore, the volume of the melody can be controlled according to the change in the second stream data.

In the music generation device, the melody generation unit may change the raising or lowering of the melody, the rhythm, and the chord in units of beats, change the volume in units of bars, and change the musical instrument in units of musical pieces or bars.

With this configuration, since the raising or lowering of the melody, the rhythm, and the chord are changed in units of beats, the volume is changed in units of bars, and the musical instrument is changed in units of musical pieces or bars, it is possible to generate a melody without discomfort.

In the music generation device, the melody adjustment unit may move a pitch of a sound that is not included in the key of the accompaniment among a plurality of sounds constituting one beat of the melody to a pitch of the closest sound in a chord of the key.

With this configuration, a pitch of a sound that is not included in the key of the accompaniment among a plurality of sounds constituting one beat of the melody is moved to a pitch of the closest sound in a chord of the key, it is possible to generate a harmonized melody.

The music generation device may further include a plurality of decision functions for a plurality of levels indicating intensity of the melody, in which each of the plurality of levels may include a plurality of bands that define an amount of change in the second stream data, each of the plurality of decision functions may be a function that defines a setting content of the melody corresponding to each of the plurality of bands, and the melody generation unit may set a decision function corresponding to any one of the plurality of levels, and generate the melody based on a setting content of the set decision function.

With this configuration, a decision function corresponding to any one of the plurality of levels indicating the intensity of the melody is set, a band corresponding to the amount of change in the second stream data is determined among the plurality of bands defined by the set decision function, and the melody is generated based on the setting content of the determined band. Therefore, it is possible to control the intensity of the melody generated by selecting the level.

In the music generation device, the setting content of the melody defined by the decision function may include at least one of a slope in raising or lowering of the melody, a rhythm of one beat, or a probability of a chord to be included in one beat.

With this configuration, since at least one of the slope in the raising or lowering of the melody, the rhythm of one beat, and the probability of the chord to be included in one beat is set, the flashiness of the melody can be changed according to the amount of change in the second stream data.

The music generation device may further include an ignition condition that defines in advance a condition as to whether or not to produce each of a plurality of melodies, in which the melody generation unit may include, in the melody information, one or more melodies satisfying the ignition condition.

With this configuration, the number of melodies to be produced can be changed according to the ignition condition.

In the music generation device, the ignition condition may include any of a case where an amount of change in the second stream data exceeds a certain threshold, a case where a set time condition is satisfied, and a case where a set event has occurred.

With this configuration, each of the plurality of melodies can be produced or not produced according to any one of the amount of change in the second stream data, the set time condition, and the occurrence of the set event.

A music generation method according to another aspect of the present disclosure is a music generation method performed by a processor of a music generation device that generates music, the music generation method including: acquiring first stream data and second stream data different from the first stream data; generating accompaniment information, which is music data indicating an accompaniment, based on a change in the first stream data; generating melody information, which is music data indicating a melody, based on a change in the second stream data; adjusting the melody information in accordance with a key of the accompaniment indicated by the generated accompaniment information; combining the accompaniment information and the adjusted melody information to generate musical piece information; and outputting the generated musical piece information.

With this configuration, it is possible to provide a music generation method capable of obtaining the same effect as that of the music generation device.

A recording medium according to still another aspect of the present disclosure is a non-transitory computer-readable recording medium for recording a music generation program in a music generation device that generates music, the music generation program causing a processor of the music generation device to perform: acquiring first stream data and second stream data different from the first stream data; generating accompaniment information, which is music data indicating an accompaniment, based on a change in the first stream data; generating melody information, which is music data indicating a melody, based on a change in the second stream data; adjusting the melody information in accordance with a key of the accompaniment indicated by the generated accompaniment information; combining the accompaniment information and the adjusted melody information to generate musical piece information; and outputting the generated musical piece information.

With this configuration, it is possible to provide a recording medium for recording a music generation program capable of obtaining the same effect as that of the music generation device.

The present disclosure can also be implemented as a music generation system that operates by such a music generation program. Furthermore, it goes without saying that such a music generation program can be distributed by using a computer-readable non-transitory recording medium such as a CD-ROM or a communication network such as the Internet.

Note that all the embodiments described below are specific examples of the present disclosure. Numerical values, shapes, constituent elements, steps, the order of steps, and the like described in the following embodiments are merely examples, and are not intended to limit the present disclosure. Further, among the constituent elements in the following embodiments, a constituent element that is not described in an independent claim indicating the most superordinate concept is described as an arbitrary constituent element. Further, in all the embodiments, the respective contents can be combined.

### First Embodiment

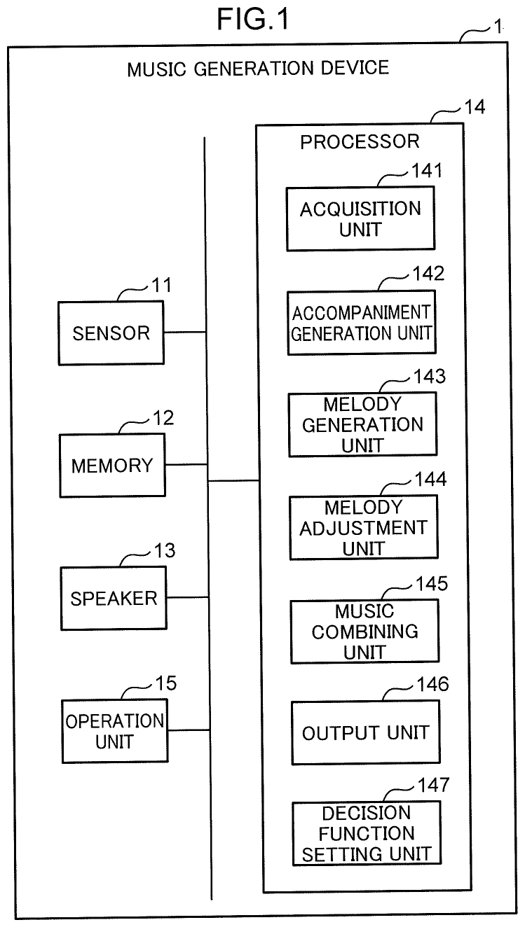

FIG. 1 is a block diagram illustrating an example of a configuration of a music generation device 1 according to a first embodiment of the present disclosure. The music generation device 1 includes a sensor 11, a memory 12, a speaker 13, an operation unit 15, and a processor 14. These constituent elements are connected to each other via a bus line.

The sensor 11 is one or more sensors that detect information on an environment around the music generation device 1 in time series at a predetermined sampling rate. Examples of the sensor 11 include an image sensor, a temperature sensor, and a position sensor. Sensing data detected by the sensor 11 is input to the processor 14 at a predetermined sampling rate.

The memory 12 is implemented by a storage device such as a random access memory (RAM), a read only memory (ROM), or a flash memory. The memory 12 stores in advance, for example, a music generation program for causing a computer to function as the music generation device 1 and data necessary for the processor to perform various processings.

The speaker 13 is a device that converts sound waveform data into a sound. For example, the speaker 13 converts sound waveform data indicated by musical piece information output from an output unit 146 into a sound and outputs the sound to the outside. As a result, a person around the music generation device 1 can listen to a musical piece indicated by the musical piece information.

The operation unit 15 includes an output device such as a display and an input device such as a keyboard and a mouse, and receives a decision function selection instruction from a user.

The processor 14 is implemented by, for example, a central processing unit, and includes an acquisition unit 141, an accompaniment generation unit 142, a melody generation unit 143, a melody adjustment unit 144, a music combining unit 145, the output unit 146, and a decision function setting unit 147. These constituent elements are implemented by the processor 14 executing the music generation program. However, this is merely an example, and each block included in the processor 14 may be implemented by a dedicated semiconductor circuit.

The acquisition unit 141 acquires, as input data, sensing data generated by the sensor 11. The input data includes first stream data and second stream data different from the first stream data. Here, the input data is so-called stream data that changes over time. For example, the input data may be a moving image data string obtained by an image sensor capturing an image of an environment around the music generation device 1 at a predetermined frame rate, may be a temperature data string detected in time series at a predetermined sampling rate by a temperature sensor, or may be a position data string detected in time series at a predetermined sampling rate by a position sensor. The acquisition unit 141 generates the first stream data and the second stream data from the input data, and inputs the first stream data and the second stream data to the accompaniment generation unit 142 and the melody generation unit 143, respectively. For example, in a case where the input data is a moving image data string, the acquisition unit 141 may directly input, as the first stream data, the moving image data string to the accompaniment generation unit 142. For example, it is sufficient if the acquisition unit 141 extracts an object included in each image frame from a moving image data string, and inputs, as the second stream data, a data string of object information indicating the extracted object to the melody generation unit 143.

The input data may be obtained by multiplexing a plurality of pieces of stream data. In this case, the acquisition unit 141 may demultiplex the multiplexed stream data as necessary and process the individual stream data. For example, in a case where a moving image data string as the input data and a data string of object information generated by processing an image data string constituting the moving image from the outside are taken in as multiplexed stream data, the acquisition unit 141 demultiplexes the stream data, inputs the moving image data string as the first stream data to the accompaniment generation unit 142, and inputs the data string of the object information as the second stream data to the melody generation unit 143.

Note that data acquired by the acquisition unit 141 may be data of data (for example, a moving image file) recorded in a file instead of the sensing data input from the sensor 11. In this case, the acquisition unit 141 may acquire, as the input data, a file recorded in the memory 12, or may acquire, as the input data, a file acquired via a network such as the Internet. Furthermore, the input data may be data other than data related to an environmental change in the outside world. For example, the input data may be a data string that changes over time, such as a stock price.

The accompaniment generation unit 142 generates accompaniment information, which is music data indicating an accompaniment, based on a change in the first stream data. Here, it is assumed that the first stream data is a moving image data string. The music data is symbol information in which music performance information such as a sound production timing, pitch, a strength, and a length of each of a plurality of sounds constituting music, and a musical instrument are indicated in such a way as to be recognizable by the processor 14. For example, the music data is information in a MIDI format.

The accompaniment is preferably generated in units of bars. This is because in a case where the accompaniment is generated in units shorter than bars, music tends to be unstable and uncomfortable.

The accompaniment generation unit 142 generates the accompaniment information in units of bars. The number of bars serving as a unit may be one or may be a number larger than one such as two or four, and it is sufficient if the number of bars serving as a unit may be set according to the purpose of music to be expressed and the nature of the input data. For example, in a case of generating an accompaniment that fluctuates to some extent by using the input data having a relatively short fluctuation cycle such as a flow of people or noise in a town, the accompaniment generation unit 142 may generate the accompaniment information with one bar as a unit. On the other hand, in a case of generating a stable accompaniment with little fluctuation by using the input data having a long fluctuation cycle such as a flow of clouds or a change in outside temperature, the accompaniment generation unit 142 may generate the accompaniment information with four bars or eight bars as a unit.

The accompaniment generation unit 142 may sample the input first stream data (moving image data string) at a time interval corresponding to the number of bars as a unit (for example, one bar), and generate the accompaniment information having a length corresponding to the time interval based on the color and brightness distribution of pixels included in the sampled image frame. For example, the accompaniment generation unit 142 may generate the accompaniment information by using an automatic music generation algorithm disclosed in JP 6058192 B2 and JP 2017-219699 A. This automatic music generation algorithm is an algorithm that divides an image into lattice-shaped blocks on a vertical axis corresponding to pitch of a sound and a horizontal axis corresponding to a duration of a sound, determines a representative color of each block, determines a color name corresponding to the representative color of each block from among a range of a plurality of color attribute values and color names associated with a plurality of sound source names, and selects each block whose color name has been determined according to predetermined criteria to generate a graphic musical score. For example, in this algorithm, a key is determined in such a way that a major key is used in a case where an image indicating the graphic musical score is overall bright, and a minor key is used in a case where an image is overall dark. A chord is determined by rearranging the blocks in such a way that sounds in each column of the graphic musical score become a chord, and the strength of a sound is determined in proportion to the brightness of each block. However, this is merely an example, and the accompaniment generation unit 142 may generate an accompaniment by using various automatic music generation algorithms other than this automatic generation algorithm.

Note that the generated accompaniment information includes, for example, sound production information such as MIDI and information on a key of each beat. This key information is used for generating melody information.

Hereinabove, the accompaniment generation unit 142 has been described.

The melody generation unit 143 generates the melody information, which is music data indicating a melody, based on a change in the second stream data.

Here, the second stream data will be described as a data string of the number of objects included in the input moving image data string.

A melody is required to have high followability to a change in the input data. Therefore, the melody generation unit 143 basically generates a sound constituting a melody for each beat. Here, one or more sounds constituting one beat of a melody are referred to as a “melody sound”.

The melody generation unit 143 may sample the input second stream data (the data string of the number of objects) at a time interval corresponding to one beat to generate the melody information for one beat.

For example, in a case of generating a melody in four/four time having a tempo of 120 BPM, the melody generation unit 143 samples the second stream data every 0.5 seconds corresponding to a time width of one beat to generate one melody sound. In a case where the tempo is fast, the sampling interval becomes short, and in a case where the tempo is slow, the sampling interval becomes long. One melody is formed by continuously generating such a melody sound according to the flow of the input data.

The melody generation unit 143 can use the following musical elements in order to convert a change in the second stream data into the melody information.

(Raising or Lowering)

The degree of change in the input data is expressed in such a way that the flow of the melody is greatly raised and lowered when the input data greatly changes, and the melody flows slowly when the amount of change in the input data is small. Therefore, the melody generation unit 143 determines whether to raise or lower pitch of a melody sound or to maintain the same pitch without changing the pitch according to the change in the second stream data. Further, in a case of raising or lowering the melody, the melody generation unit 143 determines how steep or how gentle the slope in raising or lowering the melody is.

For example, when the amount of change in the second stream data is larger than a predetermined threshold, the melody generation unit 143 determines, as the slope, a value proportional to the amount of change. On the other hand, when the amount of change in the second stream data is smaller than the predetermined threshold, the melody generation unit 143 determines to maintain the pitch of the melody sound. Further, the melody generation unit 143 may determine the flow of the melody in such a way as to be intuitive. For example, the melody generation unit 143 may raise the pitch with a positive slope when the change in the second stream data increases and may lower the pitch with a negative slope when the change in the second stream data decreases. However, this is merely an example, and a different determination may be made. In addition, the melody generation unit 143 may change the slope in raising or lowering the melody in stages based on the amount of change in the second stream data.

(Rhythm)

A rhythm often refers to a feature of arrangement of sounds of an entire musical piece, such as “samba rhythm”, but in the present embodiment, the rhythm refers to “arrangement of durations of sounds” in one local beat.

The degree of change in the input data is expressed in such a way that the rhythm of the melody sounds changes in a wide range when the input data greatly changes, and the rhythm of the melody sounds does not change when the amount of change in the input data is small. Therefore, the melody generation unit 143 determines a combination of notes and rests constituting the melody sound according to the amount of change in the second stream data. In a case where the melody is in four/four time, for example, the melody generation unit 143 produces the melody sound with one quarter note when the amount of change in the second stream data is smaller than a predetermined threshold. On the other hand, the melody generation unit 143 produces the melody sound with a combination of an eighth note, a sixteenth note, a rest, and the like when the amount of change in the second stream data is larger than the predetermined threshold. For example, “one beat=eighth note+sixteenth note+sixteenth note” or “one beat=sixteenth note+sixteenth rest+sixteenth note+sixteenth note”.

In this way, when the amount of change in the second stream data is small, the melody is in a slow rhythm. In particular, it is likely that the pitch of the melody sound is maintained the same when the amount of change in the second stream data is small as described in the above section “raising or lowering”, and thus, the melody generation unit 143 may apply a tie in a music playing technique when notes with the same pitch continue to connect these notes to make a longer note. As a result, when the amount of change in the second stream data is small, the melody generation unit 143 can compose a melody with a long single sound. On the other hand, when the amount of change in the second stream data is large, the melody sound becomes a combination of a short note and a short rest, and the melody has a rhythm with a dynamic feeling. Furthermore, in this case, the melody generation unit 143 does not need to make all the pitches of the sounds constituting the melody sound the same, and may raise and lower the pitches within a certain range. This makes it possible to generate a more dynamic melody. Furthermore, in this case, the melody generation unit 143 may determine whether or not to raise or lower the pitch and how much the pitch is to be raised or lowered by a random function. Further, the melody generation unit 143 may determine whether or not to raise or lower the pitch and how much the pitch is to be raised or lowered based on the past history of the change in the input data, instead of using the random function.

(Chord)

The degree of change in the input data is expressed in such a way that the melody sound with a chord is produced when the input data greatly changes, and the melody sound with a single sound is produced when the amount of change in the input data is small.

The chord includes a triad including the root, the third, and the fifth, and a tetrad including the root, the third, the fifth, and the seventh.

In general, as compared to a case of producing a sound with a single sound, a sound with a chord can be heard more beautifully. By using this characteristic, when the amount of change in the second stream data is smaller than a predetermined threshold, the melody generation unit 143 composes a melody sound with a single sound to give a gentle expression. On the other hand, when the amount of change in the second stream data is larger than the predetermined threshold, the melody generation unit 143 composes a melody sound with a chord to give a dynamic expression.

By combining this with the processing described in the above section “rhythm”, the melody generation unit 143 can generate a more dynamic melody in which one beat is constituted by a combination of a single sound and a chord such as “single eighth note+sixteenth note chord+single sixteenth note”, as compared with a combination of single sounds.

(Volume)

The degree of change in the input data is expressed in such a way that the volume of the melody is increased to be conspicuous when the input data greatly changes, and the volume of the melody is decreased to be moderate when the amount of change in the input data is small. Simply, the melody generation unit 143 may set the volume of the melody sound to be small when the amount of change in the second stream data is smaller than a predetermined threshold, and may set the volume of the melody sound to be large when the amount of change in the second stream data is larger than the predetermined threshold. However, in this case, the volume may wobble every beat, and a melody that sounds very uneasy may be generated. Therefore, the melody generation unit 143 may calculate the amount of change in the second stream data in a macro unit (for example, with one bar as a unit) and determine the volume of the entire bar based on the calculation result. As the amount of change in the second stream data in a macro unit, for example, an average value of the amounts of change in the second stream data in a macro unit can be adopted.

(Musical Instrument)

The feeling of a melody is greatly changed by a musical instrument that plays the melody. The musical instrument referred to herein includes not only a musical instrument played by a person but also a synthesized sound of a synthesizer or an environmental sound (sound effect) sampled in advance such as bird barking.

Although the rhythm and chord of a melody vary for each beat, it is common that a musical instrument assigned to one melody does not change from the beginning to the end of a musical piece, or does not change over several bars. As described above, a musical instrument for a melody needs to be selected a priori regardless of the input data.

For example, a musical instrument that has a clear tone and easily follows a change, such as a piano, may be assigned to main input data, a musical instrument having a gentle tone like a string instrument may be assigned to secondary input data, and a musical instrument such as a bell or a drum may be assigned to emphasize a single change in the input data.

Hereinabove, the musical elements used to convert a change in the input data into the melody information have been described.

Depending on the purpose or aspect of expressing a change in the input data by using a melody, a melody that greatly and dynamically changes in response to the amount of change may be desirable even in a case of the same amount of change in the input data. Conversely, a melody that changes slowly and gently regardless of a change in the input data may be desirable.

Therefore, the melody generation unit 143 may determine the raising or lowering, the rhythm, and the chord among the musical elements of a melody by using a “decision function”.

The decision function is a step function in which the amount of change in the second stream data is taken as an input and an output monotonically increases. In this step function, an input value becomes the same output value between a certain threshold and the next threshold.

With the decision function, it is possible to control the sensitivity of the musical element of a melody to the change in the second stream data by changing a threshold range of a section defining a step and a slope (output increment value) according to the step.

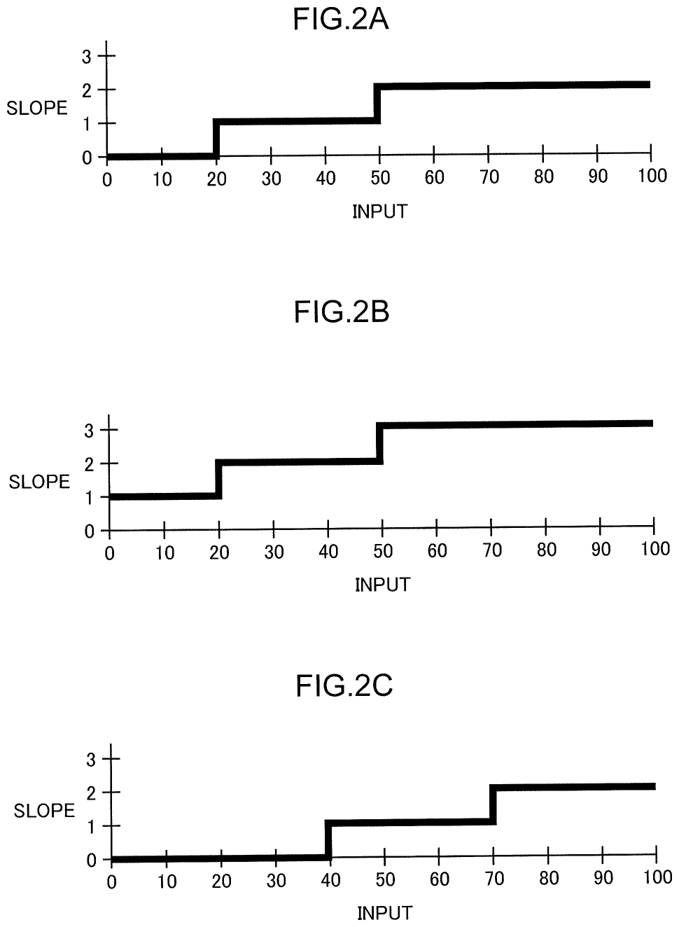

Hereinafter, a case where a melody is raised or lowered will be described as an example. FIGS. 2A, 2B, and 2C are diagrams illustrating a mechanism of a decision function that determines raising or lowering of a melody.

FIG. 2A illustrates an example of a decision function in which, when the amount of change in the second stream data (input) is “0 to 20 (a lower limit threshold of the section is 0, and an upper limit threshold is 20)”, the slope in raising is set to “0 (the same pitch is maintained)”, when the amount of change in the second stream data is “21 to 50”, the slope is set to “1 (the pitch is raised by one step)”, and when the amount of change in the second stream data is “51 to 100”, the slope is set to “2 (the pitch is raised by two steps)”. Here, the amount of change in the second stream data is a relative value when the maximum amount of change is “100”.

FIG. 2B is an example of a decision function in which each slope is different in a state where the same sections as those in FIG. 2A are set. Specifically, there is a case where the slope is set to “1” when the amount of change in the second stream data (input) is “0 to 20”, the slope is set to “2” when the amount of change in the second stream data is “21 to 50”, and the slope is set to “3” when the amount of change in the second stream data is “51 to 100”. As the decision function of FIG. 2B is used, there is a higher possibility that a melody in which the pitch is raised and lowered more steeply than in a case of FIG. 2A is formed.

FIG. 2C is an example of a decision function in which setting of sections is different in a state where the setting of the slope as in FIG. 2A is maintained. Specifically, there is a case where the slope is set to “0” when the amount of change in the second stream data (input) is “0 to 40”, the slope is set to “1” when the amount of change the second stream data is “41 to 70”, and the slope is set to “2” when the amount of change the second stream data is “71 to 100”. As the decision function of FIG. 2C is used, sensitivity to the amount of change in the second stream data becomes lower than in a case of FIG. 2A, and it is more likely that a melody that is raised or lowered slowly is generated.

The decision function setting unit 147 has a predetermined decision function list, and displays options on a display of the operation unit 15, for example. Then, when a user selects an appropriate decision function with a mouse or the like, the decision function setting unit 147 sets the decision function in the melody generation unit 143. Furthermore, examples of a method other than the user's selection may include a method in which an index representing a decision function to be used in the decision function list is multiplexed with the input data, the index of the decision function is sensed when the acquisition unit 141 demultiplexes the stream data, the acquisition unit 141 notifies the decision function setting unit 147 of the sensing result, the decision function setting unit 147 extracts the decision function corresponding to the index from the held decision function list and sets the decision function in the melody generation unit 143.

In a case where the decision function setting unit 147 sets a decision function for raising or lowering a melody in the melody generation unit 143, the melody generation unit 143 generates, from the input data, a melody that is raised or lowered with a slope according to the decision function.

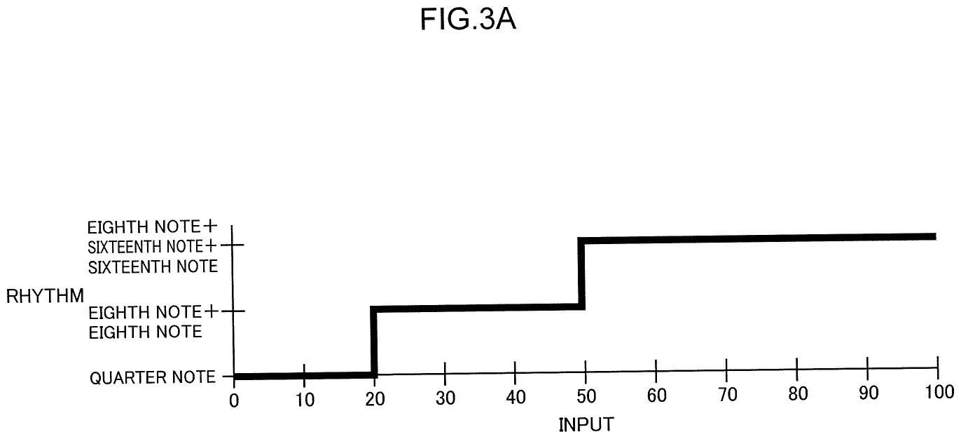

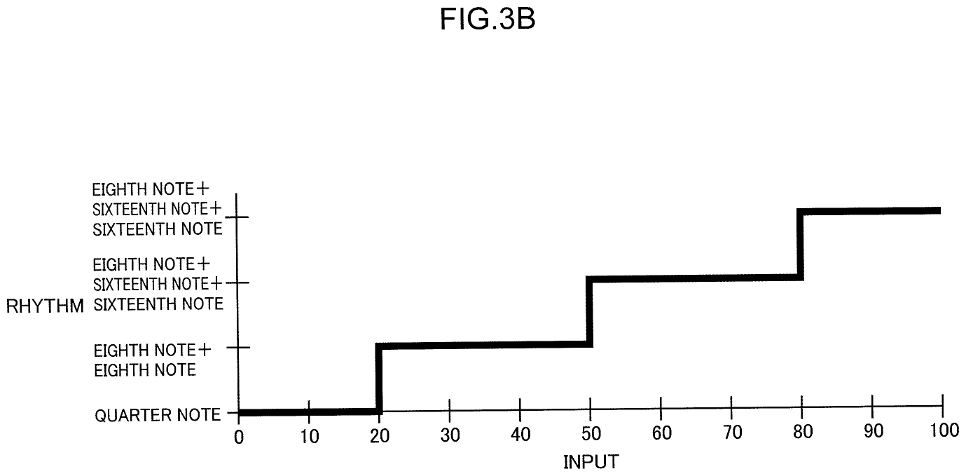

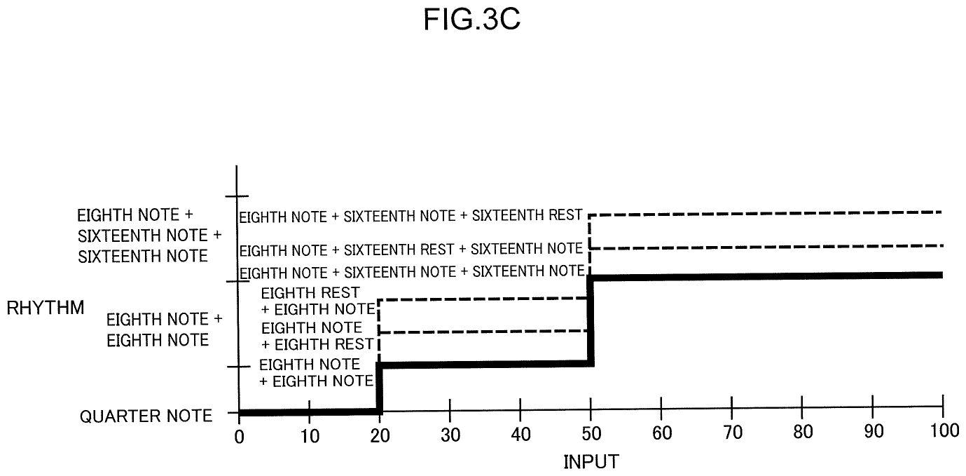

The rhythm of the melody also changes by changing the decision function. FIG. 3A is a diagram illustrating a mechanism of a decision function for determining a rhythm of a melody.

FIG. 3A illustrates an example of a decision function in which the composition of the melody sound is set to “quarter note” when the amount of change in the second stream data (input) is “0 to 20”, the composition of the melody sound is set to “eighth note+eighth note” when the amount of change in the second stream data is “21 to 50”, and the composition of the melody sound is set to “eighth note+sixteenth note+sixteenth note” when the amount of change in the second stream data is “51 to 100”. At this time, a rest may be added to the melody sound in order to further increase a change in the rhythm. For example, FIG. 3B illustrates an example of a decision function in which the composition of the melody sound is set to “eighth note+sixteenth rest+sixteenth note” when the amount of change in the second stream data is “81 to 100” in addition to the pattern of “eighth note+sixteenth rest+sixteenth note”. As a result, when the amount of change in the input data increases, the melody has a more dynamic rhythm as compared with FIG. 3A.

Alternatively, a decision function in which components of a melody sound randomly change. For example, FIG. 3C is an example of a decision function similar to the decision function of FIG. 3A, in which when the amount of change in the second stream data is “21 to 50”, any of “eighth note+eighth note”, “eighth note+eighth rest”, or “eighth rest+eighth note” is randomly determined, and when the amount of change in the second stream data is “51 to 100”, any of “eighth note+sixteenth note+sixteenth note”, “eighth note+sixteenth rest+sixteenth note”, or “eighth note+sixteenth note+sixteenth rest” is randomly determined. Note that this random selection method may be stochastically determined using a well-known random function or the like. When such a decision function is used, the variety of a rhythm of a melody is widened, and when the amount of change in the input data increases, a more dynamic rhythm than that in FIG. 3A is generated.

In a case where the decision function setting unit 147 sets a decision function for a rhythm of a melody in the melody generation unit 143, the melody generation unit 143 generates, from the input data, a melody sound with a rhythm according to the decision function.

Further, by individually raising and lowering the sounds constituting the generated melody sound, it is possible to further change the rhythm of the melody. When the composition of the melody sound is other than a quarter note, the pitch of each sound constituting the melody may be raised or lowered by several steps, so that the melody has a more dynamic rhythm.

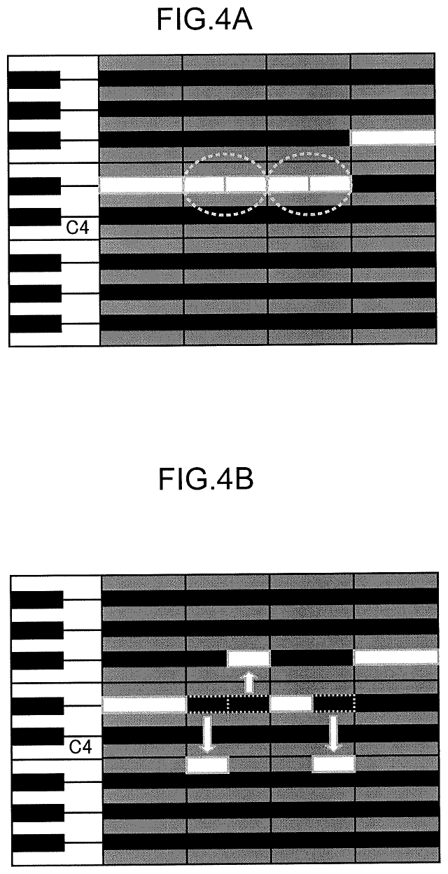

FIGS. 4A and 4B are diagrams illustrating a mechanism for changing a rhythm of a melody by adjusting a melody sound, in which a melody of one bar is displayed in the form of a piano roll. For example, a case where the melody generation unit 143 generates a melody of one bar as illustrated in FIG. 4A by using a certain decision function will be considered. The melody of one bar includes a quarter note of “D # (Re #)” for the first beat, two eighth notes of “D #” for the second beat, two eighth notes of “D #” for the third beat, and a quarter note of “F # (Fa #)” for the fourth beat, and has a relatively relaxed flow.

Here, in FIG. 4A, attention is paid to the second and third beats surrounded by circles. For example, the pitch of the sound of the eighth note for the first half of the second beat is lowered by five steps to move to “Ti (B)” in a lower octave, and the pitch of the sound of the eighth note for the second half is raised by four steps to move to “F #” in the octave. Then, the pitch of the sound of the eighth note for the first half of the third beat is not changed to maintain “D #” as it is, and the pitch of the sound of the eighth note for the second half is lowered by 5 steps to move to “Ti (B)” in a lower octave. Then, as illustrated in FIG. 4B, a melody in which sound is splashed is obtained.

As described above, when the composition of the melody sound that is being generated is other than a quarter note, the melody generation unit 143 can generate a melody having a more dynamic rhythm by adding processing of raising and lowering the pitch of each sound constituting the melody sound by several steps. Note that the melody generation unit 143 may stochastically determine, by using a random function or the like, selection of a sound whose pitch is to be raised or lowered among the sounds constituting the melody sound and how much the pitch of each sound is to be raised or lowered.

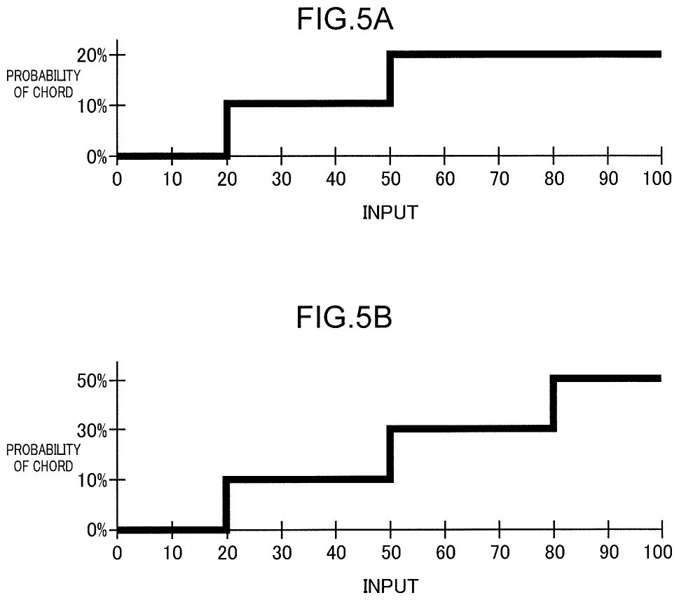

The chord of the melody also changes by changing the decision function. FIG. 5A is a diagram illustrating a mechanism of a decision function that determines the use of a chord of a melody.

FIG. 5A illustrates an example of a decision function in which the probability that the melody sound includes a chord is set to “0% (always a single sound)” when the amount of change in the second stream data (input) is “0 to 20”, the probability is set to “10%” when the amount of change in the second stream data is “21 to 50”, and the probability is set to “20%” when the amount of change in the second stream data is “51 to 100”.

FIG. 5B is an example of a decision function in which the same probability as in FIG. 5A is set when the amount of change in the second stream data (input) is “0 to 50”, the probability that the melody sound includes a chord is set to “30%” when the amount of change in the second stream data is “51 to 80”, and the probability is set to “50%” when the amount of change in the second stream data is “81 to 100”.

As the decision function in FIG. 5B is used, the probability that the constituent sound of the melody sound is a chord increases as the amount of change in the second stream data increases as compared with a case in FIG. 5A, so that a flashier melody is generated.

In a case where the decision function setting unit 147 sets a decision function for a chord of a melody in the melody generation unit 143, the melody generation unit 143 generates, from the input data, a melody in which a melody sound is produced with a chord at a probability according to the decision function.

Hereinabove, the melody generation unit 143 has been described.

The melody adjustment unit 144 adjusts a key of the melody information generated by the melody generation unit 143 in accordance with a key of the accompaniment indicated by the accompaniment information generated by the accompaniment generation unit 142. The pitch of each sound constituting the melody sound generated by the melody generation unit 143 does not necessarily match the key (tone) of the beat of the accompaniment. In this case, the melody sound has a pitch that does not match the key of the accompaniment, so that a discord is produced, and an unpleasant music is generated. Therefore, the melody adjustment unit 144 moves the pitch of a constituent sound that does not match the key of the accompaniment among a plurality of sounds constituting the melody sound generated by the melody generation unit 143 to the pitch of the closest constituent sound among the constituent sounds of the key.

Specifically, in a case where the pitch of the sound constituting the melody sound generated by the melody generation unit 143 is the first, the third, or the fifth (in addition, the seventh when using a tetrad) from the root of the key of the beat of the accompaniment, the melody adjustment unit 144 adopts the pitch as it is. On the other hand, in a case where the pitch of the melody sound is not the first, the third, or the fifth (in addition, the seventh when using a tetrad) from the root of the key of the beat of the accompaniment, the melody adjustment unit 144 may move the pitch of the corresponding sound to the pitch of the closest sound among the first, the third, and the fifth (in addition, the seventh when using a tetrad). Thus, the pitch of the melody sound can be matched with the key of the accompaniment.

Note that, although it has been described here that the pitch does not exceed one octave, even in a case of a compound interval larger than one octave, it is sufficient if the compound interval is reduced to a simple interval by subtracting one or several octaves.

The music combining unit 145 combines the accompaniment information generated by the accompaniment generation unit 142 and the melody information adjusted by the melody adjustment unit 144 to generate musical piece information. The musical piece information is music data including the accompaniment information and the adjusted melody information.

The output unit 146 outputs the musical piece information generated by the music combining unit 145 to the outside via the speaker 13. Specifically, the output unit 146 converts the musical piece information into sound waveform data, and outputs the converted sound waveform data to the outside via the speaker 13. As a result, music following a change in the input data is output.

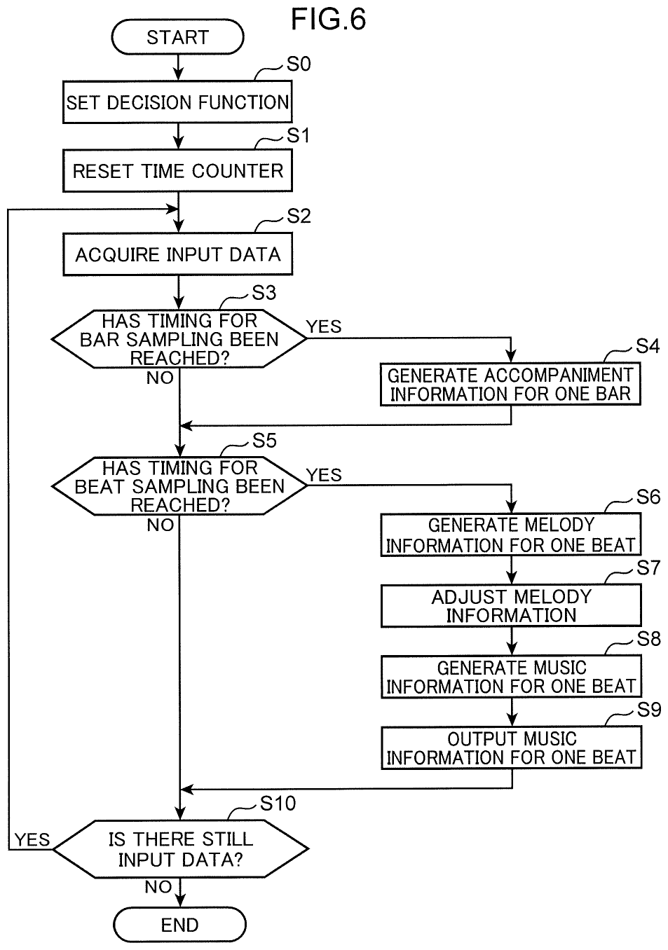

Hereinabove, the configuration of the music generation device 1 has been described. Next, processing performed by the music generation device 1 will be described. FIG. 6 is a flowchart illustrating an example of the processing performed by music generation device 1 according to the first embodiment of the present disclosure. Here, it is assumed that the input data is a moving image data string obtained by imaging an environment around the music generation device 1, image frames constituting a moving image are used as the first stream data, and the second stream data is information on the number of people extracted from each image frame constituting the moving image.

In Step S0, the decision function setting unit 147 sets the decision function for the raising or lowering of the melody, the rhythm of the melody, or the chord of the melody to be used by the melody generation unit 143, the decision function being selected by the user through the operation unit 15.

In Step S1, the acquisition unit 141 resets a time counter to 0. The time counter is constantly clocked in milliseconds, for example.

In Step S2, the acquisition unit 141 acquires the first stream data and the second stream data from the input data of the sensing data detected by the sensor 11. That is, the image frame is acquired as the first stream data, and the information on the number of people extracted from the image frame is acquired as the second stream data. The first stream data and the second stream data are acquired, for example, every 0.1 seconds.

In Step S3, the acquisition unit 141 determines whether or not the time counter has reached a bar sampling timing. For example, in a case where the tempo is 120 BPM, the length of one bar is two seconds, and thus, whether or not the bar sampling timing has been reached can be easily determined by determining whether or not the time counter has reached two seconds.

In a case where the bar sampling timing has been reached (YES in Step S3), the processing proceeds to Step S4, and the accompaniment generation unit 142 generates the accompaniment information. Otherwise (NO in Step S3), the accompaniment generation unit 142 proceeds to Step S5 without generating the accompaniment information.

In Step S4, the accompaniment generation unit 142 applies the above-described automatic music generation algorithm to the first stream data to generate the accompaniment information for one bar.

In Step S5, the acquisition unit 141 determines whether or not the time counter has reached a beat sampling timing. For example, in a case where the tempo is 120 BPM, the length of one beat is 0.5 seconds, and thus, whether or not the beat sampling timing has been reached can be easily determined by determining whether or not the time counter has reached 0.5 seconds.

In a case where the beat sampling timing has been reached (YES in Step S5), the processing proceeds to Step S6, and the melody generation unit 143 generates the melody information. Otherwise (NO in Step S5), the melody generation unit 143 proceeds to Step S10 without generating the melody information.

In Step S6, the melody generation unit 143 generates the melody information based on the amount of change in the data acquired from the second stream data. For example, the amount of change in the data may be calculated by comparing data acquired at the immediately previous beat sampling timing (0.5 seconds before) with data acquired this time, may be calculated by comparing the immediately previous data of the second stream data acquired (data of 0.1 seconds before) with data acquired this time, or may be calculated by comparing an average value of several pieces of previous data (for example, the third previous data=0.3 seconds before) of the second stream data with data acquired this time.

The melody generation unit 143 inputs the amount of change in the data to the decision function for each of the raising or lowering of the melody, the rhythm, and the chord set in Step S0 to determine the slope in the raising or lowering of the melody, the rhythm, and the chord, and generates the melody information of the melody sound for one beat of the melody. Note that, here, among the musical elements of the melody, the volume and the musical instrument are not particularly specified, and any fixed musical instrument and volume are used from the beginning to the end. However, for example, any condition may be set to change the musical instrument and the volume of the melody in Step S6.

In Step S7, the melody adjustment unit 144 adjusts the melody information in such a way that the melody sound generated in Step S6 matches the key of the beat based on the accompaniment information of the bar generated in Step S4.

In Step S8, the music combining unit 145 generates musical piece information for one beat from the accompaniment information of the bar generated in Step S4 and the melody information of the melody sound adjusted in Step S7.

In Step S9, the output unit 146 converts the musical piece information for one beat generated in Step S8 into sound waveform data, and outputs the converted sound waveform data to the outside via the speaker 13. For example, in a case where the musical piece information is MIDI data, when a MIDI sequencer and a synthesizer are used, waveform data for one beat is generated from the MIDI data.

In Step S10, it is determined whether or not there is still input data. In a case where there is still input data (YES in Step S10), the processing returns to Step S2 and continues. In a case where there is not more input data (NO in Step S10), the processing ends.

As described above, according to the present embodiment, the melody indicated by the melody information generated for each beat based on the change in the second stream data is adjusted in accordance with the key of the accompaniment indicated by the accompaniment information generated for each bar based on the change in the first stream data, the accompaniment information and the adjusted melody information are combined, the musical piece information indicating the music piece is generated, and the musical piece information is output. As a result, it is possible to generate music that maintains a balance between followability to input data and emotionality of music.

### Second Embodiment

In a second embodiment, the decision function described in the first embodiment can be simply and structurally set by a “level”. Note that, in the present embodiment, the same components as those in the first embodiment are denoted by the same reference signs, and a description thereof will be omitted.

The level is a set of decision functions of related musical elements that enables easy setting of intensity (or moderation) of a melody to be generated can be easily set. Here, the intensity of the melody is the depth of an impression given to a listener depending on the degree of change in pitch, volume, rhythm, and the like, and in general, the higher the degree of change, the more intense the impression.

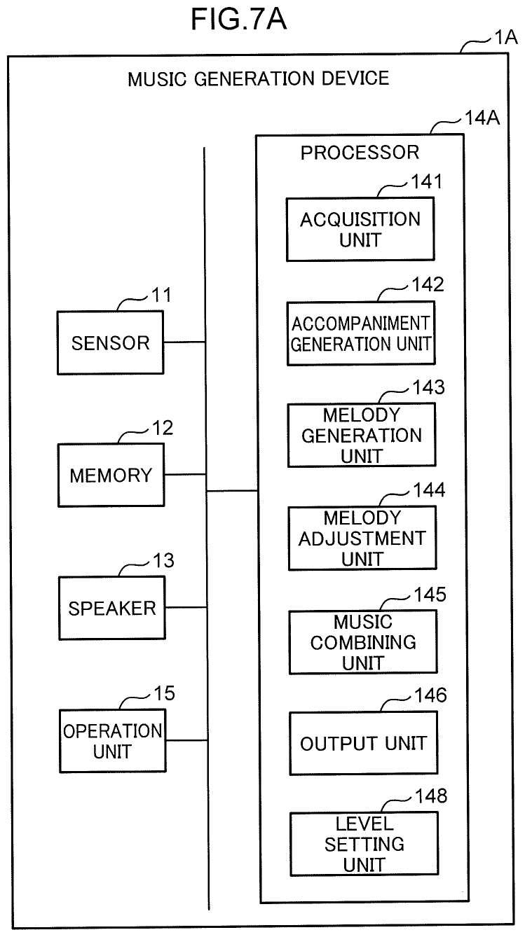

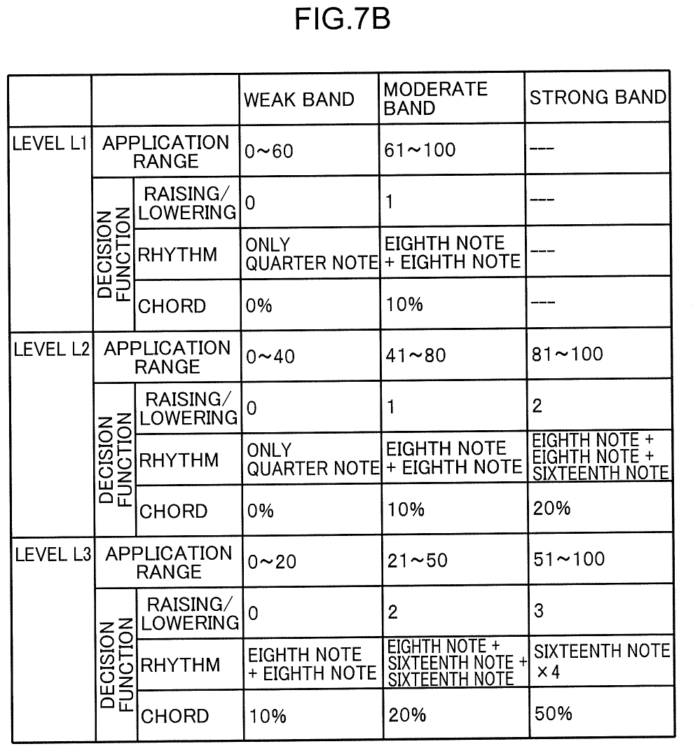

FIG. 7B is a table illustrating an example of setting contents of the decision functions for each level. In this example, it is assumed that there are three levels, the gentlest “level L1” to the most intense “level L3”, and the decision functions for the raising or lowering of the melody, the rhythm of the melody, and the chord of the melody corresponding to these three levels are determined in advance.

Each level is divided into a plurality of “bands” divided according to the amount of change in the second stream data. In this example, there are three bands, a “weak band”, a “moderate band”, and a “strong band”. The “weak band” is a band corresponding to a situation where the amount of change in the second stream data is small, and the stronger the band, the larger the amount of change in the second stream data.

Output values of the decision functions for the raising or lowering of the melody, the rhythm of the melody, and the chord of the melody in application ranges of these bands are set. In the first embodiment, the application ranges of the decision functions are individually defined. However, in the present embodiment, by unifying the application ranges of the decision functions using bands, a melody in which these musical elements are compositely combined can be easily set.

The application range of each band is defined by an upper limit value and a lower limit value of a threshold of the amount of change in the second stream data. The application range of each band is set in such a way as not to overlap with that of an adjacent band and not to have a gap from that of an adjacent band. As will be described later, the application range of the band may be empty.

Next, band setting for each level will be described.

It is desirable that the lower the level, the more easily a gentle melody is generated, and the higher the level, the more easily an intensely dynamic melody is generated. In this regard, the application range of the weak band is widened, and the application range of the strong band is narrowed (or empty) for a low level. By doing so, the probability that an input value to the decision function (that is, the amount of change in the second stream data) falls within the range of the weak band increases, and as a result, the possibility of generating a gentle melody increases. Conversely, as the application range of the strong band is widened, and the application range of the weak band is narrowed for a high level, the probability that an input value to the decision function falls within the range of the strong band increases, and as a result, the possibility of generating an intense melody increases.

This will be described with reference to FIG. 7B. For example, in a case where the level L1 is selected, if the amount of change in the second stream data is “55”, a melody generation unit 143 selects the musical element of the weak band since the amount of change in the second stream data falls within the application range (“0 to 60”) of the weak band. That is, the slope in the raising or lowering of the melody is set to “0”, the rhythm of one beat is set to “quarter note”, and the probability of the chord of one beat is set to “0% (that is, a single sound)”. In this case, a gentle melody that is little raised or lowered is generated.

Furthermore, for example, in a case where the level L2 is selected, if the amount of change in the second stream data is “55” which is the same as the above example, the melody generation unit 143 selects the musical element of the moderate band since the amount of change in the second stream data falls within the application range (“41 to 80”) of the moderate band, the slope in the raising or lowering of the melody is set to “1”, the rhythm of one beat is set to “eighth note+eighth note”, and the probability of the chord is set to “10%”. In this case, a melody whose pitch is slightly raised or lowered is generated by a combination of eighth notes with a chord added sometimes.

Furthermore, for example, in a case where the level L3 is selected, if the amount of change in the second stream data is “55” which is the same as the above example, the melody generation unit 143 selects the musical element of the strong band since the amount of change in the second stream data falls within the application range (“51 to 100”) of the strong band, the slope in the raising or lowering of the melody is set to “3”, the rhythm of one beat is set to “four sixteenth notes”, and the probability of the chord is set to “50%”. As a result, a dynamic melody whose pitch is greatly raised and lowered is generated by a combination of sixteenth notes that are chords at a high probability.

FIG. 7A is a block diagram illustrating an example of a configuration of a music generation device 1A according to the second embodiment of the present disclosure. The music generation device 1A includes a level setting unit 148 instead of the decision function setting unit 147 of the music generation device 1.

The level setting unit 148 has a predetermined level list, and displays options on a display of an operation unit 15, for example. Then, when a user selects an appropriate level with a mouse or the like, the level setting unit 148 sets the decision function of the musical element defined in the level in the melody generation unit 143.

Hereinabove, the configuration of the music generation device 1A has been described. Next, processing performed by the music generation device 1A will be described. A flowchart illustrating an example of the processing performed by the music generation device 1A according to the second embodiment of the present disclosure is substantially the same as the flowchart in FIG. 6 of the first embodiment. The only difference is that, in Step S0, the level setting unit 148 sets a decision function for the raising or lowering of the melody, the rhythm of the melody, or the chord of the melody to be used by the melody generation unit 143, based on the level selected by the user through the operation unit 15. The other configurations are the same as those of the first embodiment, and thus a description thereof will be omitted.

As described above, according to the present embodiment, a character of a melody to be generated can be easily changed only by selecting a level.

In this example, three levels and three bands are set, but other settings are applicable. For example, in a case where the number of levels or bands is increased, a range of “gentle” to “intense” of a melody to be generated can be widened. Furthermore, in this example, one decision function is defined for each of the sets of levels and bands, but the present disclosure is not limited thereto, and a set of a plurality of decision functions distributed at a certain probability may be included for each of the sets of levels and bands. For example, the decision function for the rhythm for the level L2 and the moderate band may be set in such a way that “eighth note+eighth note” is used at the probability of 40%, “eighth note+eighth rest” is used at the probability of 20%, “eighth rest+eighth note” is used at the probability of 20%, “eighth note+sixteenth note+sixteenth note” is used at the probability of 20%, instead of using “eighth note+eighth note” in a fixed manner. In this case, the generated melody becomes a non-deterministic rhythm that is influenced by chance, and becomes more dynamic.

### Third Embodiment

According to a third embodiment, musical piece information having a plurality of melodies is generated. Note that, in the present embodiment, the same components as those in the second embodiment are denoted by the same reference signs, and a description thereof will be omitted.

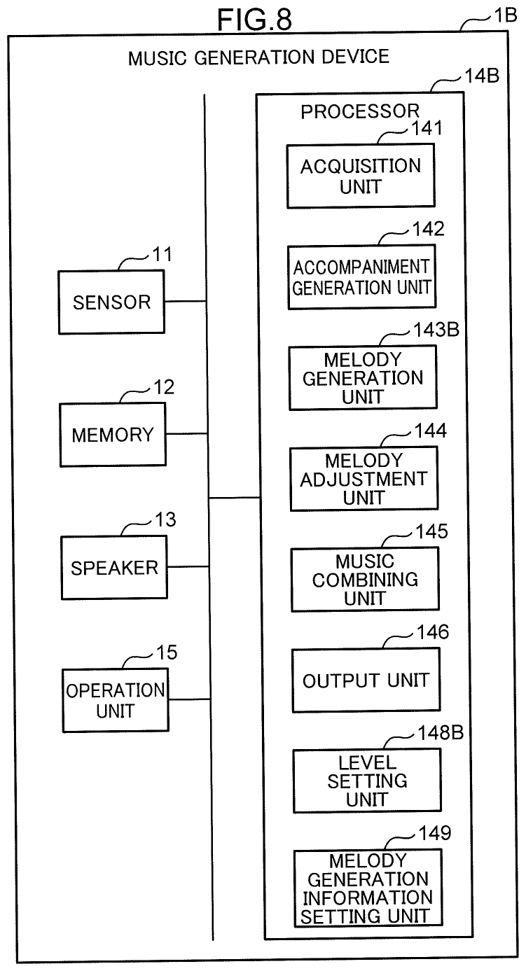

FIG. 8 is a block diagram illustrating an example of a configuration of a music generation device 1B according to the third embodiment of the present disclosure.

A processor 14B further includes a melody generation unit 143B, a level setting unit 148B, and a melody generation information setting unit 149.

The melody generation unit 143B includes, in melody information, only a melody satisfying an ignition condition that defines in advance a condition as to whether or not to produce each of a plurality of melodies by referring to the ignition condition.

The melody generation information setting unit 149 has a predetermined melody generation information list, and displays options for each melody on a display of an operation unit 15, for example. There are three types of melody generation information: a level, a musical instrument, and an ignition condition. Then, when a user selects appropriate melody generation information with a mouse or the like, the melody generation information setting unit 149 sets the musical instrument and the ignition condition among the pieces of melody generation information for the melody in the melody generation unit 143B. Then, the melody generation information setting unit 149 sets the level among the pieces of the melody generation information in the level setting unit 148B.

The level setting unit 148B sets a set of decision functions for musical elements defined in the level set by the melody generation information setting unit 149 in the melody generation unit 143B.

In a case where a plurality of melodies are produced with an accompaniment, a range of an expression of music is widened. Simply, music becomes flashier when a plurality of melodies are produced than when only one melody is produced. In addition, as each melody is associated with a change in corresponding input data, a musical pieces dynamically expressing a change in a plurality of pieces of data is obtained.

Specifically, in a case where a plurality of pieces of stream data are included in the second stream data, when an individual melody is assigned to each stream data, the melody generation unit 143B can generate the melody information for each melody by the method according to the second embodiment to generate a musical pieces having a plurality of melodies.

However, it is not preferable to constantly produce a plurality of melodies. It is desirable that a large number of melodies are played at a climax of music like an orchestral performance, and only one or a small number of melodies are played otherwise. Therefore, in a case where a condition as to “whether or not to produce” (referred to as the “ignition condition”) is set for each melody, and the melody is produced only when the condition is satisfied, it is possible to generate a musical piece in which such melodies overlap each other. In addition, it is possible to generate a musical piece having various effects by controlling whether or not to produce a melody depending on the lapse of time or an external event.

Next, the ignition condition for the melody will be described. Here, as examples of the ignition condition, three conditions including a condition that the amount of change in the second stream data exceeds a certain threshold (condition C1), a condition that a set time condition is satisfied (condition C2), and a condition that a set event has occurred (condition C3) will be described.

The condition C1 is a condition that, for example, in a case where the threshold is set to 50, the melody is not played when the amount of change in the second stream data is small (less than 50), and the melody is played when the amount of change in the second stream data is 50 or more. When different thresholds are set for a plurality of melodies, music such as an orchestral performance in which the number of melodies to be played increases or decreases depending on the amount of change in the second stream data can be obtained.

The condition C2 is a condition that a certain melody is played for 20 seconds every 5 minutes.

The condition C3 is a condition that an event unrelated to the second stream data is set, and when the event has occurred, the melody is played. Examples of the event include a case where the remaining battery level becomes equal to or less than a certain level, and a case where a human sensor detects a person.

Generation of a plurality of melodies will be described with specific examples.

For example, a live moving image from a fixed point camera in a downtown is used as the input data, and setting is made in such a way that a piano melody changes depending on the number of people in the moving image, and a trumpet melody is added when the number of people becomes equal to or larger than a certain threshold. In addition, a chime melody is added for 10 seconds every 10 minutes, and a drum melody is produced while an external sensor different from the fixed point camera is in an on state (for example, the external sensor is turned on in a case where a temperature sensor detects a temperature exceeding 35° C.), so that a total of four melodies are generated.

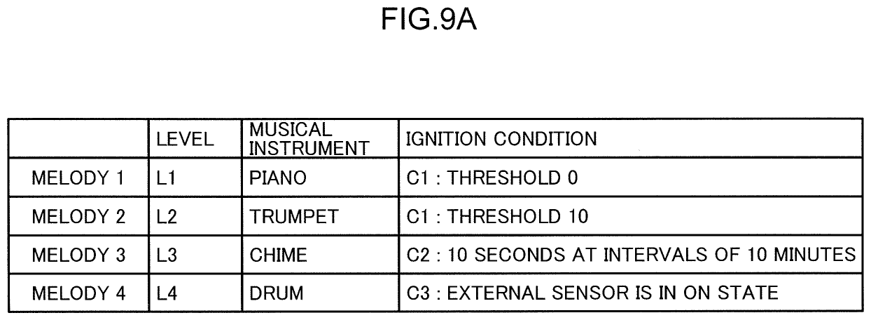

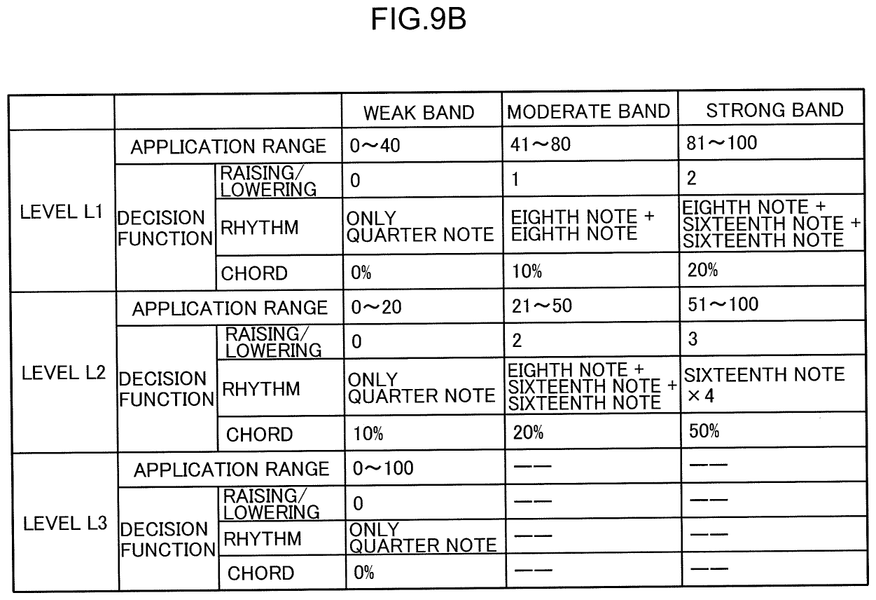

FIG. 9A illustrates the melody generation information of each melody. FIG. 9B illustrates the decision functions for the levels L1 to L3 included in the melody generation information.

A melody “1” is set in such a way that a piano melody always flows while changing (level L1) relatively slowly in accordance with the increase or decrease in the number of people shown in the moving image. Since the threshold of the ignition condition is 0 under the condition C1, the melody “1” always satisfies the ignition condition regardless of the amount of change in the second stream data. Specifically, in a “weak band” in which the amount of change in the second stream data is 40 or less, a melody in which a quarter note and a single sound are used and a change in a pitch is very small is generated. In a “moderate band” in which the amount of change in the second stream data is 41 to 80, a melody in which eighth notes are used and a chord is sometimes added and which is slightly raised and lowered is generated. In a “strong band” in which the amount of change in the second stream data is 81 or more, a melody in which an eighth note and sixteenth notes are mixed and more chords are produced and which is more greatly raised and lowered is generated.

A melody “2” is set in such a way that a trumpet melody that greatly changes (level L2) flows when the number of people increases. Since the threshold of the ignition condition is 10 under the condition C1, the melody “2” flows only when the amount of change in the second stream data exceeds 10. Specifically, when the amount of change in the second stream data is 10 or less, the ignition condition is not satisfied, and thus the melody “2” is not produced. In the “weak band” in which the amount of change in the second stream data is 11 to 20, a melody in which a quarter note is used and a chord is added at a probability of 10% and which is rarely raised and lowered is generated. In the “moderate band” in which the amount of change in the second stream data is 21 to 50, a melody in which an eighth note and sixteenth notes are mixed and a chord is added at a probability of 20% and which is slightly raised and lowered is generated. In the “strong band” in which the amount of change in the second stream data is 51 or more, an intense melody in which sixteenth notes are used and a chord is produced at a probability of 50% and which is greatly raised and lowered is generated.

A melody “3” is set in such a way that a chime melody flows at the level L3 only for 10 seconds at intervals of 10 minutes regardless of the moving image since the ignition condition is satisfied only for 10 seconds at intervals of 10 minutes. Specifically, the decision function generates a melody in which a quarter note and a single sound are used and which is not raised or lowered in all input ranges.

A melody “4” is also set in such a way that a drum melody is produced at the level L3 only during a time when a temperature exceeds 35° C. regardless of the moving image since the ignition condition is satisfied when the temperature exceeds 35° C.

According to this example, when the amount of change in the second stream data is 10 or less, only the piano melody “1” is slowly produced, when the amount of change in the second stream data exceeds 11, the trumpet melody “2” is added, and the rhythms of the melody “1” and the melody “2” become intense with different slopes as the amount of change increases. Further, it is possible to create music that follows changes in the outside world in various ways that, for example, the chime melody “3” is produced only for 10 seconds at intervals of 10 minutes, and the drum melody “4” is produced during a time when the temperature exceeds 35° C. regardless of the amount of change in the second stream data.

Next, processing performed by the music generation device 1B according to the present embodiment will be described.

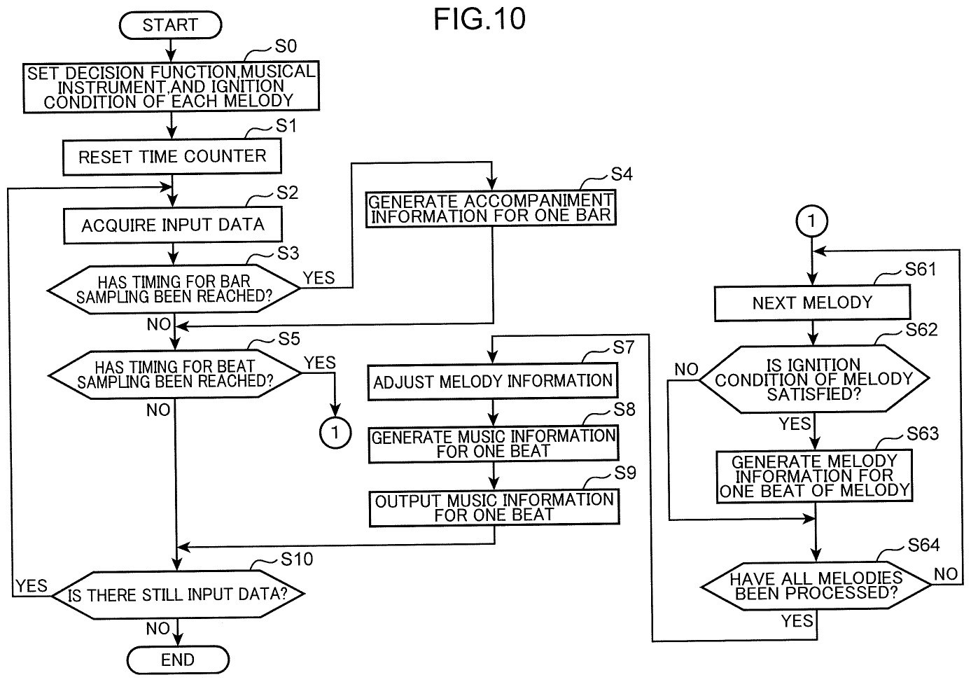

FIG. 10 is a flowchart illustrating an example of the processing performed by the music generation device 1B according to the third embodiment of the present disclosure.

Since this flowchart is similar to the flowchart of FIG. 6 of the first embodiment, the same components as those of the first embodiment are denoted by the same reference signs, and a description thereof will be omitted.

In Step S0, the melody generation information setting unit 149 sets a musical instrument and an ignition condition among the pieces of melody generation information for each melody in the melody generation unit 143B, based on the melody generation information selected by the user through the operation unit 15. Then, the melody generation information setting unit 149 sets the level among the pieces of the melody generation information in the level setting unit 148B. The level setting unit 148B sets the decision function for the musical element defined in the set level in the melody generation unit 143B.

In Step S5, an acquisition unit 141 determines whether or not a time counter has reached a beat sampling timing, and in a case where the time counter has reached the beat sampling timing (YES in Step S5), the processing proceeds to Step S61.

In Step S61, the melody generation unit 143B acquires the melody generation information (the level, the musical instrument, and the ignition condition) of the next melody. Specifically, once the processing proceeds from Step S5 to Step S61, the melody generation information of the melody “1” is acquired. Once the processing proceeds from Step S64 to Step S61, the melody generation information of the next melody is acquired. For example, in a case where the melody “1” has been processed immediately before, the melody generation information of the melody “2” is acquired.

In Step S62, the melody generation unit 143B evaluates the ignition condition of the acquired melody generation information. In a case where the ignition condition is the condition C1, the melody generation unit 143B compares the amount of change in the second stream data with a threshold set in the ignition condition, and evaluates that the ignition condition is satisfied in a case where the amount of change in the second stream data is larger than the threshold. In a case where the ignition condition is the condition C2, the melody generation unit 143B evaluates the ignition condition by using the time counter, a time interval set in the ignition condition, and a duration. In this example, in a case where the remainder obtained by dividing the current time counter (for example, 900000 (=15×60×1000) in a case where 15 minutes have elapsed from Step S0) by the time interval (600000=60×10×1000 in this example) is equal to or less than the duration (10000 in this example), the melody generation unit 143B evaluates that the ignition condition is satisfied. In a case where the ignition condition is the condition C3, the melody generation unit 143B evaluates a state of the sensor set as the ignition condition at that time and evaluates that the ignition condition is satisfied in a case where the sensor is in an on state.

In a case where the ignition condition is satisfied (YES in Step S62), the processing proceeds to Step S63, and the melody generation unit 143B generates the melody information of the melody. Otherwise (NO in Step S62), the melody generation unit 143B proceeds to Step S64 without generating the melody information.

In Step S63, the melody generation unit 143B generates the melody information of the melody. The melody generation unit 143B determines the slope in the raising or lowering of the melody, the rhythm, and the chord by using the set decision functions for the raising or lowering of the melody, the rhythm, and the chord based on the amount of change in the second stream data, and generates the melody information of the melody sound for one beat of the melody. In addition, the musical instrument set in the melody generation information is used.

In Step S64, the melody generation unit 143B determines whether or not all the melodies have been processed, and in a case where all the melodies have been processed, the melody generation on this beat is completed (YES in Step S64), and thus the processing proceeds to Step S7. Otherwise (NO in Step S64), the processing returns to Step S61, and the next melody is processed.

According to the third embodiment, there are a plurality of melodies which is raised or lowered and in which the rhythm, the chord, and the like change according to the amount of change in the input data, and an individual ignition condition is set for each of the melodies. Therefore, it is possible to appropriately bundle the plurality of melodies, and as a result of which it is possible to automatically generate music that meets a large number of uses and purposes.

### Fourth Embodiment

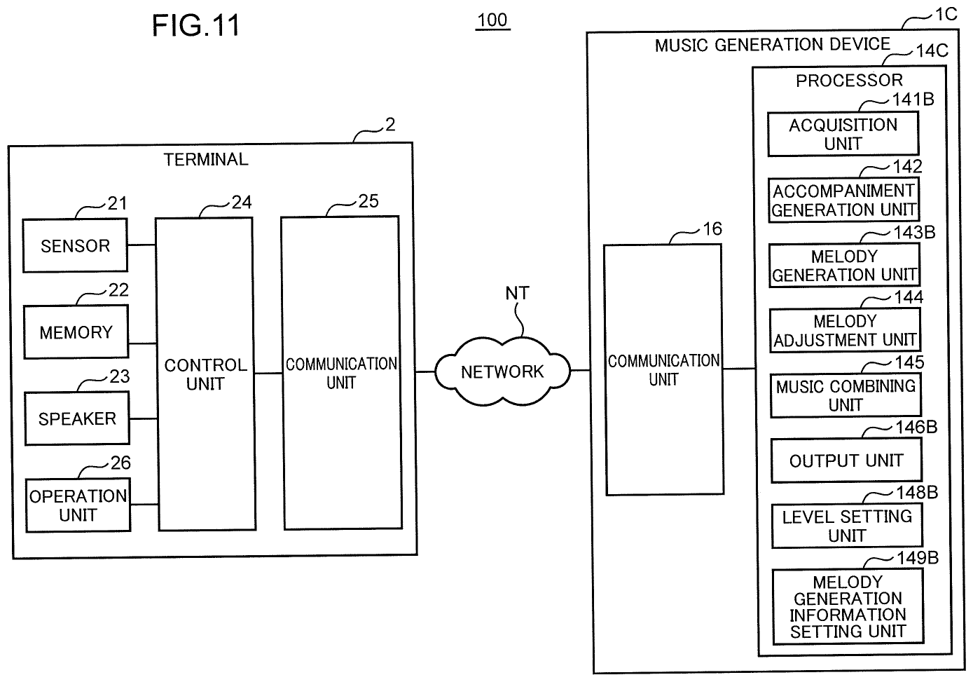

In a fourth embodiment, the music generation device 1B described in the third embodiment is applied to a cloud system. FIG. 11 is a diagram illustrating an example of an overall configuration of a music generation system 100 according to the fourth embodiment of the present disclosure. Note that, in the present embodiment, the same components as those in the third embodiment are denoted by the same reference signs, and a description thereof will be omitted.

The music generation system 100 includes a music generation device 1C and a terminal 2. The music generation device 1C is implemented by a cloud server. The terminal 2 is installed at a place where a musical piece generated by the music generation device 1C is output. The terminal 2 may be implemented by a stationary computer, a tablet computer, or a smartphone. The music generation device 1C and the terminal 2 are communicably connected to each other via a network NT. The network NT is, for example, the Internet.

The music generation device 1C includes a communication unit 16 and a processor 14C. The communication unit 16 is a communication circuit that connects the music generation device 1C to the network NT. The processor 14C includes an acquisition unit 141B, an accompaniment generation unit 142, a melody generation unit 143B, a melody adjustment unit 144, a music combining unit 145, an output unit 146B, a level setting unit 148B, and a melody generation information setting unit 149B.

The acquisition unit 141B acquires sensing data of a sensor 21 transmitted from the terminal 2 by using the communication unit 16. Other functions of the acquisition unit 141B are the same as those of the acquisition unit 141.

The output unit 146B transmits musical piece information generated by the music combining unit 145 to the terminal 2 by using the communication unit 16.

The melody generation information setting unit 149B acquires melody generation information selected by an operation unit 26 of the terminal 2 by using the communication unit 16. Other functions of the melody generation information setting unit 149B are the same as those of the melody generation information setting unit 149.

The terminal 2 includes the sensor 21, a memory 22, a speaker 23, a control unit 24, a communication unit 25, and the operation unit 26. Similarly to the sensor 11 in FIG. 1, the sensor 21 generates sensing data and transmits the generated sensing data to the music generation device 1C by using the communication unit 25. The memory 22 stores data necessary for the control unit 24 to perform processing.

The control unit 24 acquires the musical piece information transmitted by the music generation device 1C by using the communication unit 25, converts the acquired musical piece information into sound waveform data, and inputs the sound waveform data to the speaker 23. The speaker 23 converts sound waveform data into a sound and outputs the sound to the outside. As a result, a musical piece following a change in the input data is output around the terminal 2. The communication unit 25 is a communication circuit that connects the terminal 2 to the network NT. The operation unit 26 is implemented by an output device such as a display and an input device such as a keyboard and a mouse, and receives a melody generation information selection instruction from a user.

As described above, according to the fourth embodiment, it is possible to implement a cloud service that generates a musical piece following a change in the input data.

Although data acquired by the acquisition unit 141B is transmitted from the sensor 21 mounted on the terminal 2 in this example, data may also be transmitted from a sensor mounted on another terminal different from the terminal 2. In addition, the data is not limited to data from a sensor, and may be data acquired via a network such as the Internet. Similarly, the speaker 23 may be a speaker mounted on another terminal different from the terminal 2.

### Application Example A1

Next, an application example of the present disclosure will be described. In Application Example A1, music based on a flow of people is generated in real time from moving image data of a fixed point camera placed in a crowded place such as a station or a shopping mall, and the generated musical piece is output from a speaker. The input data is a frame sequence of moving image data of a camera. From this frame sequence, the accompaniment generation unit 142 generates an accompaniment for each bar by the method described above. Further, it is sufficient if the accompaniment generation unit 142 generates an accompaniment by determining a combination of musical instruments, a tempo, and the like using environmental information such as a season, a time, and a temperature. Furthermore, the accompaniment generation unit 142 may generate music of different feelings according to a season, a time, and a temperature.

For example, the melody generation unit 143 performs image processing on a moving image frame to detect the number of people and a moving direction, and counts the number of people moving from right to left in a screen and the number of people moving from left to right in the screen at predetermined intervals (for example, at intervals of 0.5 seconds). The melody generation unit 143 sets these two changes in the number of people as two types of second stream data, and assigns a melody to each of the two types of second stream data. Then, different musical instruments are set for each melody. For example, the melody generation unit 143 assigns a piano to a melody corresponding to movement of people from left to right, and assigns a violin to a melody corresponding to movement of people from right to left. Then, the melody generation unit 143 selects and applies the same level in, for example, the level and band setting illustrated in FIG. 7B to the two types of second stream data to generate two pieces of melody information. As a result, music in which changes in flow of people in two directions are expressed by melodies of two musical instruments is generated. Furthermore, the melody generation unit 143 may raise the level of the melody corresponding to the movement of people from right to left, for example, to generate music that changes sensitively to the flow of people in that direction. Alternatively, the melody generation unit 143 may set a certain threshold for the movement of people from left to right, and in a case where the input data exceeds the threshold (condition C1), another melody may be output at a different level. As a result, it is possible to generate melody information that changes variously. In this way, it is possible to create various musical pieces that change in accordance with a change in input data only by setting and changing a small number of parameters.

### Application Example A2

In Application Example A2, the music generation device 1 is applied to virtual reality (VR). When VR goggles are worn, an image including a landscape is displayed on a display of the VR goggles in accordance with the orientation of the face, the walking direction, and the like, and a person wearing the VR goggles can operate objects on the screen by hand movement. A person wearing the VR goggles can have a highly stimulating visual experience by a realistic image obtained by linking movement of the body and the screen displayed on the display. However, the VR goggles according to the related art do not provide an audible experience with a high reality and great pleasure as compared with the visual experience, because a BGM such as environmental music and sound effects such as a body motion sound, a sound of a contact with objects, and a wind sound are only repeatedly output.

In a case where the present technology is applied to the VR goggles, a moving image displayed on the display of the VR goggles serves as the first stream data, and sensing data of an angle sensor included in the VR goggles, an angle sensor worn on the limbs, or the like serves as the second stream data, so that it is possible to make a person listen to music that changes in real time in accordance with movement of people, and it is possible to provide a more interesting VR experience.

### INDUSTRIAL APPLICABILITY

The present disclosure is useful in the technical field of generating music suitable for a surrounding environment because music following a change in input data can be generated.

This application is based on Japanese Patent application No. 2021-133991 filed in Japan Patent Office on Aug. 19, 2021, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A music generation device that generates music, the music generation device comprising:
an acquisition unit that acquires first stream data and second stream data different from the first stream data;
an accompaniment generation unit that generates accompaniment information, which is music data indicating an accompaniment, based on a change in the first stream data;
a melody generation unit that generates melody information, which is music data indicating a melody, based on a change in the second stream data;
a melody adjustment unit that adjusts the melody information in accordance with a key of the accompaniment indicated by the generated accompaniment information;
a music combining unit that combines the accompaniment information and the adjusted melody information to generate musical piece information; and
an output unit that outputs the generated musical piece information.

2. The music generation device according to claim 1, wherein the second stream data includes a plurality of pieces of stream data, and
the melody generation unit generates the melody information indicating a plurality of melodies based on a change in each of the plurality of pieces of stream data.

3. The music generation device according to claim 1, wherein the accompaniment generation unit generates the accompaniment information in units of bars, and
the melody generation unit generates the melody information in units of beats.

4. The music generation device according to claim 1, wherein the melody generation unit changes at least one of raising or lowering of the melody, a rhythm, a chord, a volume, or a musical instrument based on the change in the second stream data.

5. The music generation device according to claim 1, wherein the melody generation unit changes a slope in raising or lowering of the melody based on an amount of change in the second stream data in a case where the amount of change is larger than a predetermined threshold, and the melody generation unit does not change the slope in the raising or lowering of the melody in a case where the amount of change is smaller than the predetermined threshold.

6. The music generation device according to claim 1, wherein the melody generation unit expresses a rhythm by generating the melody in such a way that one beat is constituted by sounds represented by a plurality of notes in a case where an amount of change in the second stream data is larger than a predetermined threshold, and generating the melody in such a way that one beat is constituted by a sound represented by one note in a case where the amount of change is smaller than the predetermined threshold.

7. The music generation device according to claim 6, wherein at least one of the plurality of notes constituting one beat of the melody is a rest.

8. The music generation device according to claim 1, wherein the melody generation unit generates the melody in such a way that one beat is constituted by a sound including a chord in a case where an amount of change in the second stream data is larger than a predetermined threshold, and the melody generation unit generates the melody in such a way that one beat is constituted by a single sound in a case where the amount of change in the second stream data is smaller than the predetermined threshold.

9. The music generation device according to claim 1, wherein the melody generation unit sets a volume of the melody to a first volume in a case where an amount of change in the second stream data is larger than a predetermined threshold, and the melody generation unit sets the volume of the melody to a second volume lower than the first volume in a case where the amount of change in the second stream data is smaller than the predetermined threshold.

10. The music generation device according to claim 4, wherein the melody generation unit changes the raising or lowering of the melody, the rhythm, and the chord in units of beats, changes the volume in units of bars, and changes the musical instrument in units of musical pieces or bars.

11. The music generation device according to claim 1, wherein the melody adjustment unit moves a pitch of a sound that is not included in the key of the accompaniment among a plurality of sounds constituting one beat of the melody to a pitch of a closest sound in a chord of the key.

12. The music generation device according to claim 1, further comprising a plurality of decision functions for a plurality of levels indicating intensity of the melody,
wherein each of the plurality of levels includes a plurality of bands that define an amount of change in the second stream data,
each of the plurality of decision functions is a function that defines a setting content of the melody corresponding to each of the plurality of bands, and
the melody generation unit sets a decision function corresponding to any one of the plurality of levels, and generates the melody based on a setting content of the set decision function.

13. The music generation device according to claim 12, wherein the setting content of the melody defined by the decision function includes at least one of a slope in raising or lowering of the melody, a rhythm of one beat, or a probability of a chord to be included in one beat.

14. The music generation device according to claim 1, further comprising an ignition condition that defines in advance a condition as to whether or not to produce each of a plurality of melodies,
wherein the melody generation unit includes, in the melody information, one or more melodies satisfying the ignition condition.

15. The music generation device according to claim 14, wherein the ignition condition includes any of a case where an amount of change in the second stream data exceeds a certain threshold, a case where a set time condition is satisfied, and a case where a set event has occurred.

16. A music generation method performed by a processor of a music generation device that generates music, the music generation method comprising:
acquiring first stream data and second stream data different from the first stream data;
generating accompaniment information, which is music data indicating an accompaniment, based on a change in the first stream data;
generating melody information, which is music data indicating a melody, based on a change in the second stream data;
adjusting the melody information in accordance with a key of the accompaniment indicated by the generated accompaniment information;
combining the accompaniment information and the adjusted melody information to generate musical piece information; and
outputting the generated musical piece information.

17. A non-transitory computer-readable recording medium for recording a music generation program in a music generation device that generates music, the music generation program causing a processor of the music generation device to perform:
acquiring first stream data and second stream data different from the first stream data;
generating accompaniment information, which is music data indicating an accompaniment, based on a change in the first stream data;
generating melody information, which is music data indicating a melody, based on a change in the second stream data;
adjusting the melody information in accordance with a key of the accompaniment indicated by the generated accompaniment information;
combining the accompaniment information and the adjusted melody information to generate musical piece information; and
outputting the generated musical piece information.
